(19) United States
(12) Patent Application Publication
(10) Pub. No.: US 2018/0174587 A1
(43) Pub. Date: Jun. 21, 2018

(54) AUDIO TRANSCRIPTION SYSTEM

(71) Applicant: KYOCERA Document Solution Inc., Osaka (JP)

(72) Inventor: Neil-Paul Bermundo, Concord, CA (US)

(73) Assignee: KYOCERA Document Solution Inc., Osaka (JP)

(21) Appl. No.: 15/382,222

(22) Filed: Dec. 16, 2016

(51) Int. Cl. G10L 15/26; G10L 15/04; G10L 25/51; G06F 17/21; G10L 25/84; G10L 25/81; G10L 15/02; G10G 1/04; G06K 15/02; G06F 3/12

(52) U.S. Cl. CPC G10L 15/26; G10L 15/04; G10L 25/51; G06F 17/211; G10L 25/84; G10L 25/81; G10L 2015/025; G10G 1/04; G06K 15/1807; G06F 3/1205; G06F 3/1245; G06F 3/1248; G10L 15/02

(57) ABSTRACT

A method of generating a transcript file in a selected presentation format from input audio data with a transcription component. The transcription component divides the input audio data into individual sound tokens. The transcription component then identifies transcription text for subsets of the sound tokens by finding a best match for the subset in sound samples in a sound database. The transcription component then creates a transcript file and formats the transcription text in the transcript file according to a presentation format that corresponds to a sound type of the transcription text.

### BACKGROUND

### Field of the Invention

The present disclosure relates to the generation of transcription text from input audio data, particularly the generation of a transcript file that can be printed or displayed in a selected presentation format.

### Background

Transcripts of audio recordings are often used for purposes such as analysis, education, and archiving. Transcripts allow transcribed text to be read, searched, and edited, which can be useful for users such as news agencies and other media outlets, universities and other educational institutions, researchers, libraries, and government agencies. For example, news organizations often search transcripts of recorded interviews and broadcasts when performing research for a news story.

Unfortunately, manually transcribing an audio recording into text can be tedious and time-consuming. Some software systems have been developed that can generate transcribed text from audio recordings more quickly. However, such applications often output generated text without formatting that corresponds to the content and/or context of the source audio recording.

Users often need to manually format and edit raw text generated from automatic transcription systems into a format they want to use when printing or displaying the transcribed text. This process can also be tedious and time consuming. For example, some automatic transcription systems generate raw unformatted text when transcribing a recording of a conversation between two people. Users may then need to edit the transcribed text to separate out words spoken by each speaker, indicate which person is speaking at which time, and/or format the text so that it can be read and followed more easily as a back and forth dialog.

What is needed is a system that can transcribe audio into text and format the transcribed text according to a presentation format that corresponds to the type of audio that was transcribed, such that the text can be printed and/or displayed in the selected presentation format.

### SUMMARY

The present disclosure provides a method of generating a transcript file. Input audio data at an audio transcription device running a transcription component. The transcription component can divide the input audio data into a plurality of sound tokens. The transcription component can identify transcription text for each subset of sound tokens by finding a best match for the subset in sound samples in a sound database. The transcription component can create a transcript file and format the transcription text in the transcript file according to a presentation format that corresponds to a sound type of the transcription text.

The present disclosure also provides a printer comprising a transcription component and a print engine. The transcription component can receive input audio data when a print job is initiated at the printer, and divide the input audio data into a plurality of sound tokens. The transcription component can identify transcription text for each subset of sound tokens by finding a best match for the subset in sound samples in a sound database. The transcription component can create a transcript file and format the transcription text in the transcript file according to a presentation format that corresponds to a sound type of the transcription text. The print engine can then print images on paper based on the transcript file according to its presentation format.

The present disclosure also provides an audio transcription device comprising a processor, digital memory, a microphone, a non-transitory machine-readable medium, and a data interface. The microphone can be configured to record input audio data and store said input audio data as a digital file in the digital memory. The non-transitory machine-readable medium can have instructions recorded thereon for causing the processor to perform the steps of dividing the input audio data into a plurality of sound tokens, identifying transcription text for each subset of the plurality of sound tokens by finding a best match for the subset in sound samples in a sound database, creating a transcript file and formatting the transcription text in the transcript file according to a presentation format that corresponds to a sound type of the transcription text, and storing the transcript file in the digital memory. The data interface can be configured to transfer the transcript file from the digital memory to a separate device.

### BRIEF DESCRIPTION OF THE DRAWINGS

FIG. 1 depicts an audio source providing input audio data to an audio transcription device running a transcription component to generate a transcript file.

FIG. 2 depicts an exemplary embodiment of a sound database.

FIG. 3 depicts an exemplary embodiment of an essay format for a transcript file.

FIG. 4 depicts an exemplary embodiment of a poem format for a transcript file.

FIG. 5 depicts an exemplary embodiment of a dialog format for a transcript file.

FIG. 6 depicts an exemplary embodiment of a screenplay format for a transcript file.

FIGS. 7A-7B depicts exemplary embodiments of an illustrated book format for a transcript file.

FIG. 8 depicts an exemplary embodiment of a captioning format for a transcript file.

FIG. 9 depicts an exemplary embodiment of a musical score format for a transcript file.

FIG. 10 depicts an exemplary embodiment of a process for generating a transcript file with a transcription component.

FIG. 11 depicts an example of sound tokens identified in the sound wave of input audio data.

FIG. 11 depicts an exemplary process for selecting presentation formats for groups of sound tokens that can be combined into a final transcript file.

FIG. 12 depicts an exemplary process for creating a transcript file and printing it when the audio transcription device is a printer and an audio input file is sent to the printer to begin a print job.

### DETAILED DESCRIPTION

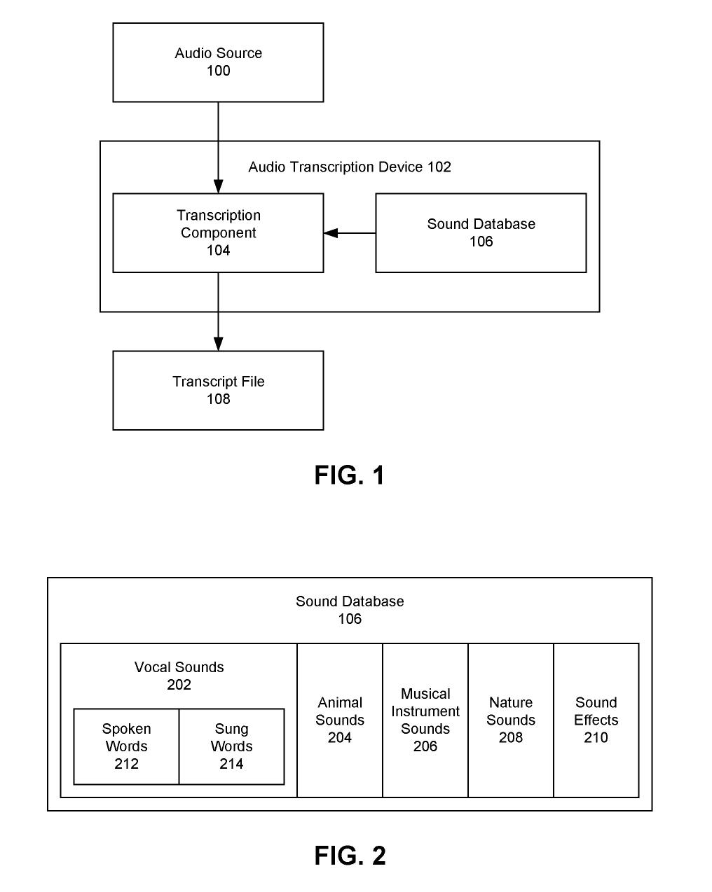

FIG. 1 depicts an audio source 100 providing input audio data to an audio transcription device 102. An audio source 100 can be a device that provides live or prerecorded audio data to the audio transcription device 102. The audio transcription device 102 can have a transcription component 104 running as software or firmware that recognizes words and/or sounds in the input audio data based on a sound database 106 and generates a transcript file 108 based on the recognized words and/or sounds. The transcript file 108 can then be printed, stored, transferred, and/or displayed.

An audio source 100 can provide live or prerecorded audio data to the audio transcription device 102 via a direct wired or wireless connection, via a network connection, via removable storage, and/or through any other data transfer method. In some embodiments the audio source 100 and the audio transcription device 102 can be directly connected via a cable such as a USB cable, Firewire cable, digital audio cable, or analog audio cable. In other embodiments the audio source 100 and the audio transcription device 102 can both be connected to the same LAN (local area network) through a WiFi or Ethernet connection such that they can exchange data through the LAN. In still other embodiments the audio source 100 and the audio transcription device 102 can be directly connected via Bluetooth, NFC (near-field communication), or any other peer-to-peer (P2P) connection. In yet other embodiments the audio source 100 can be a cloud server, network storage, or any other device that is remote from the audio transcription device 102, and the audio source 100 can provide input audio data to the audio transcription device 102 remotely over an internet connection. In still further embodiments the audio source 100 can load input audio data onto an SD card, removable flash memory, a CD, a removable hard drive, or any other type of removable memory that can be accessed by the audio transcription device 102.

In some embodiments the audio source 100 can be a device comprising a microphone that can provide live input audio data to the audio transcription device 102 while it captures sound from its surrounding environment. In other embodiments the audio source 100 can be a device that can record audio data using a microphone and/or store audio data received from other devices such that it can provide prerecorded audio data to the audio transcription device 102. By way of non-limiting examples, the audio source 100 can be a microphone, telephone, radio, MP3 player, CD player, audio tape player, computer, smartphone, tablet computer, or any other device.

In some embodiments or situations the input audio data can be an audio file or signal provided by the audio source 100. By way of a non-limiting example, the audio source 100 can provide input audio data to the audio transcription device 102 as an encoded audio file in a file format such as MP3, WAV, WMA, ALC, ARF, AAC, or any other audio file format. By way of another non-limiting example, the audio source 100 can provide input audio data to the audio transcription device 102 as analog audio signals or unencoded digital audio, and the audio transcription device 102 or transcription component 104 can convert the input audio into an encoded audio file.

In alternate embodiments or situations the input audio data can be extracted from a video file or signal provided by the audio source 100. By way of a non-limiting example, the audio source 100 can provide the audio transcription device 102 with an encoded video file in a file format such as AVI, WMV, MP4, MOV, MPG, 3GP, or any other video file format. In these embodiments, the audio transcription device 102 or transcription component 104 can extract the video's audio components to use as the input audio data. By way of a non-limiting example, when a provided video file is an MP4 file with video components encoded with H.264 and audio components encoded with MP3, the transcription component 104 can use the MP3 audio components as the input audio data. In some embodiments the audio transcription device 102 or transcription component 104 can also extract one or more frames from the video components as images to include in the transcript file 108, as discussed below. In other embodiments the transcription component 104 can include some or all of the video data in the transcript file 108, such as when the transcript file 108 is itself a video file as described below.

The audio transcription device 102 can be a computing device that comprises, or is connected to, at least one processor and at least one digital storage device. The processor can be a chip, circuit, or controller configured to execute instructions to direct the operations of the device running the audio transcription device 102, such as a central processing unit (CPU), application-specific integrated circuit (ASIC), field-programmable gate array (FPGA), graphics processing unit (GPU), or any other chip, circuit, or controller. The digital storage device can be internal, external, or remote digital memory, such as random access memory (RAM), read-only memory (ROM), electrically erasable programmable read-only memory (EEPROM), flash memory, a digital tape, a hard disk drive (HDD), a solid state drives (SSD), cloud storage, any/or any other type of volatile or non-volatile digital memory.

In some embodiments the audio transcription device 102 can be a printer, such as a standalone printer, multifunctional printer (MFP), fax machine, or other imaging device. In embodiments in which the audio transcription device 102 is a printer, the printer can directly print transcripts described by a transcript file 108 generated by the transcription component 104. In other embodiments the audio transcription device 102 can be a computer, smartphone, tablet computer, microphone, voice recorder or other portable audio recording device, television or other display device, home theater equipment, set-top box, radio, portable MP3 player or other portable media player, or any other type of computing or audio-processing device. When the audio transcription device 102 comprises a screen or can output images to a connected screen, in some embodiments the audio transcription device 102 can display a transcript file 108 on the screen. By way of a non-limiting example, when the audio transcription device 102 is a television that has a transcription component 104, the television can display on its screen text transcribed by the transcription component 104 from input audio data.

As shown in FIG. 1, in some embodiments the audio source 100 and the audio transcription device 102 can be separate devices. In these embodiments the audio source 100 can provide input audio data to the audio transcription device 102 over a USB cable, audio cable, or other wired or wireless connection. By way of a non-limiting example, a microphone can provide captured audio data to a separate multifunctional printer (MFP), and the transcription component 104 can run as firmware installed on the MFP.

In alternate embodiments the audio source 100 can be a part of the audio transcription device 102, such that the audio source 100 directly provides input audio data to the transcription component 104 running on the same device. By way of a non-limiting example the audio transcription device 102 can be a microphone unit or a standalone portable audio recording device comprising a microphone, and the transcription component 104 can be firmware running in the microphone unit or recording device that can receive audio data captured by its microphone. By way of another non-limiting example the audio transcription device 102 can be a smartphone comprising a microphone and/or other audio inputs, and the transcription component 104 can be run as an application on the smartphone.

When the audio source 100 provides live or prerecorded audio data in real time over an audio cable or other connection, the audio transcription device 102 and/or transcription component 104 can digitally record and store the audio data in digital storage. By way of a non-limiting example, the transcription component 104 can encode the received audio data into an audio file, such as an MP3 file or an audio file encoded using any other lossless or compressed format. Similarly, when an audio source 100 provides audio data as an already encoded audio file, the audio transcription device 102 and/or transcription component 104 can store the received audio file in digital storage.

The transcription component 104 can be software or firmware that follows a set of instructions to generate one or more transcript files 108 from input audio data received from an audio source 100. As will be discussed further below, the transcription component 104 can identify individual words and/or sounds present within the input audio data based on a sound database 106, and include text or descriptions associated with those words and sounds in a transcript file 108.

The sound database 106 can be a database of preloaded sound information, including prerecorded sound samples, that the transcription component 104 can use to interpret input audio data and generate a transcript file 108. As shown in FIG. 2, the sound database 106 can comprise vocal sounds 202. In some embodiments the sound database 106 can additionally comprise animal sounds 204, musical instrument sounds 206, nature sounds 208, and/or sound effects 210.

Vocal sounds 202 can comprise spoken words 212 and/or sung words 214. Spoken words 212 can be prerecorded samples of spoken words and/or spoken phonemes by one or more human speakers. Sung words 214 can be prerecorded samples of sung words and/or sung phonemes by one or more human singers.

Each sung or spoken word in the sound database 106 can be mapped to the text of an associated word in the sound database 106. By way of a non-limiting example, a recording of a person saying the word “table” can be mapped to the character string “table” in the sound database 106.

Each sung or spoken phoneme in the sound database 106 can be mapped to one or more strings of characters that can represent that phoneme in the sound database 106, along with rules for combining a character string for the phoneme with other character strings for other phonemes to create a character string for a word. By way of a non-limiting example, the sound database 106 can contain recordings of a person saying the phonemes /t/, /a/, and /bl/. When the transcription component 104 recognizes those individual phonemes being spoken together in input audio data, it can use the associated character strings to build the character string “table” for the transcript file 108.

Animal sounds 204 can be prerecorded samples of noises made by animals. By way of non-limiting examples, animal sounds 204 can be sounds such as dog barks, bird tweets, cow moos, horse neighs, or any other sound produced by an animal. Each animal sound sample in the sound database 106 can be mapped to a text description of that animal sound in the sound database 106.

Musical instrument sounds 206 can be prerecorded samples of musical sounds produced by one or more musical instruments. The sound database 106 can contain a plurality of different sound samples for each musical instrument, such as samples for different notes, chords, beats, or other sounds that the instrument can produce. Each musical sample in the sound database 106 can be mapped to a text description of that musical sound, and an identifier of which type of instrument made the sound. The text description of a musical sample can be the name of the identified note, such as a C note, and/or a solfège syllable that corresponds to its sound, such as “do,” “re,” “mi,” “fa,” “sol,” “la,” and “ti.” The sound database 106 can also comprise a plurality of musical symbols that the transcription component 104 can use to build a musical score in a transcript file 108 based on identified musical sounds, such as symbols for different notes of varying lengths that it can place on a musical staff in a transcript file 108.

Nature sounds 208 can be prerecorded samples of sounds produced by natural or atmospheric conditions. By way of non-limiting examples, nature sounds can be sounds of wind, fire, running river water, thunder, rain, waves on a beach, volcanic eruptions, or any other natural element. Each nature sound sample in the sound database 106 can be mapped to a text description of that nature sound in the sound database 106.

Sound effects 210 can be prerecorded samples of any other sounds, such as man-made sounds, sounds produced by machines, or sound effects commonly used in movies and television shows. By way of non-limiting examples, sound effects can be sounds of footsteps, clapping, tapping, whistling, drumming, car engines, airplane jets, helicopters, explosions, or any other sound effect. Each sound effect sample in the sound database 106 can be mapped to a text description of that sound effect in the sound database 106.

Returning to FIG. 1, the transcription component 104 can generate a transcript file 108 that stores text and/or other symbols associated with the identified words and sounds based on the sound database 106, along with formatting information for one or more presentation formats. In some embodiments a transcript file 108 can be digital document in a file format such as WL, DOC, PDF, or any other document format. In other embodiments a transcript file 108 can be a print job described with PDL (page description language) commands that can be interpreted by a printer to print the contents of the transcript file 108. In still other embodiments a transcript file 108 can be a video or a slideshow file that can be played on a screen, such as a computer monitor or television.

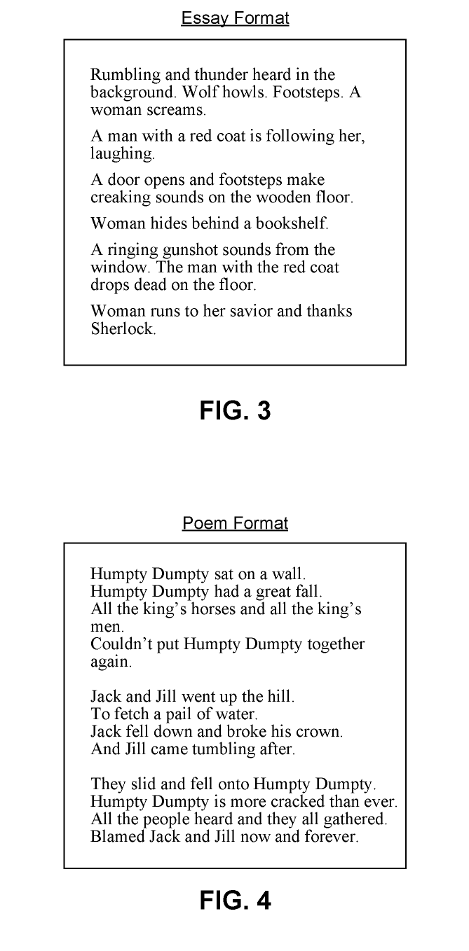

FIGS. 3-9 depict exemplary embodiments of different presentation formats that the transcription component 104 can use when generating a transcript file 108 based on identified words and/or sounds. Presentation formats for the transcript file 108 can include an essay format, a poem format, a dialog format, a screenplay format, an illustrated book format, a captioning format, a musical score format, and/or any other presentation format. The transcription component 104 can, automatically or in response to user input, select a particular presentation format to use when generating a transcript file 108 based on a type of audio in the input audio data.

FIG. 3 depicts an exemplary embodiment of an essay format. An essay format can display transcribed text formatted into paragraphs. The transcription component 104 can begin a new paragraph when pauses of more than a predefined length of time are identified in the input audio data. In some embodiments the transcription component 104 can select the essay format by default when the input audio data is identified by the transcription component 104 or via user input as a recording of speech by a single person. By way of non-limiting examples, an essay format can be selected when the input audio data is a recording of a speech, an audio book read by a single narrator, or a podcast with a single host.

FIG. 4 depicts an exemplary embodiment of a poem format. A poem format can be used to display transcribed words, such as the words of a poem or song lyrics, in separate stanzas. The transcription component 104 can begin a new stanza when pauses between spoken or sung words of more than a predefined length of time are identified in the input audio data, even when background music fills those pauses. In some embodiments the transcription component 104 can select the poem format by default when the input audio data is identified by the transcription component 104 or via user input as a poem or musical recording.

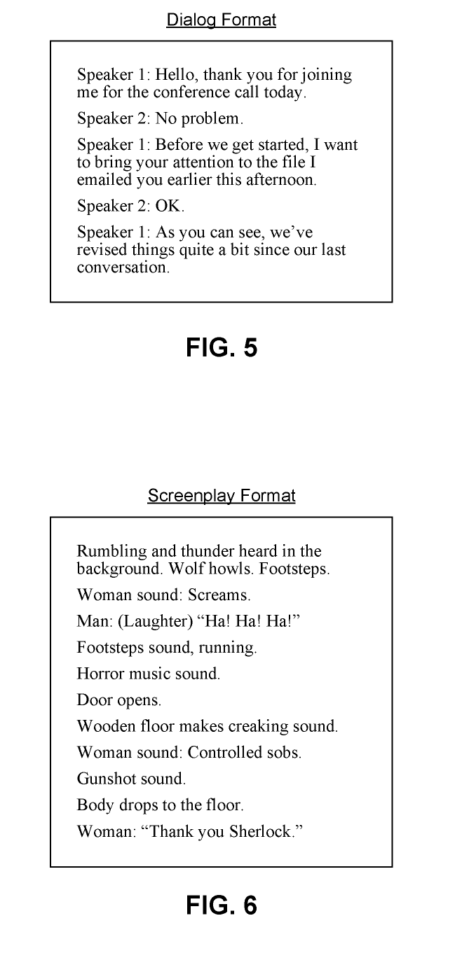

FIG. 5 depicts an exemplary embodiment of a dialog format. A dialog format can be used when more than one speaker is identified by the transcription component 104 in the input audio data, substantially without other background noise. In a dialog format each identified speaker can be associated with transcribed words that the transcription component 104 determines that they spoke in the input audio data. When a new speaker beings speaking in the input audio data, that speaker's name can be displayed along with their transcribed words.

The transcription component 104 can compare the speakers' voices against frequencies of audio samples from known speakers in the sound database 106 and attempt to find a matching speaker. If a matching speaker is found, the dialog format can list the speaker's name in front of the transcribed text. However, if no matching speaker is found but the transcription component 104 identifies distinct voices in the input audio, it can use generic identifiers such as “Speaker 1” and “Speaker 2.” In some embodiments when the frequencies of a vocal sample fall into a range that is statistically more likely to be a man's voice, a woman's voice, or a child's voice, the transcription component 104 can identify the speaker in the transcript file 108 as a “Man,” “Woman,” or “Child.”

In some embodiments the transcription component 104 can select the dialog format by default when the input audio data is identified by the transcription component 104 or via user input as a recording of a conversation between more than one person and a low level of background noise is detected. By way of a non-limiting example, a dialog format can be selected when the input audio data is a recording of two people having a phone conversation.

FIG. 6 depicts an exemplary embodiment of a screenplay format. A screenplay format can be similar to the dialog format, but also include a description of identified sounds that are not determined to be speech. As with the dialog format, each identified speaker can be associated with their transcribed words. As described above, the transcription component 104 can attempt to recognize each speaker based on vocal samples of known speakers in the sound database, or separately identify each distinct voice with a generic term or gender-specific term based on frequency analyses. When the transcription component 104 determines that a voice likely belongs to a man or a woman based on a frequency analysis, in some embodiments it can use a gender-specific pronoun when describing other actions for non-vocal data as described below.

When the transcription component 104 is set to use a screenplay format and it encounters non-vocal data in the input audio data, it can attempt to identify that non-vocal data using animal sounds 204, musical instrument sounds 206, nature sounds 208, and/or sound effects 210 in the sound database 106. When the transcription component 104 identifies non-vocal data, it can insert a text description of the sounds into the transcript file 108.

In some embodiments the transcription component 104 can select the screenplay format by default when the input audio data is identified by the transcription component 104 or via user input as an audio or video recording of a movie, television show, play, or other performance. By way of a non-limiting example, a screenplay format can be selected when three actors in a play are recorded speaking their lines and the transcription component 104 identifies three distinct voices as well as other sound effects.

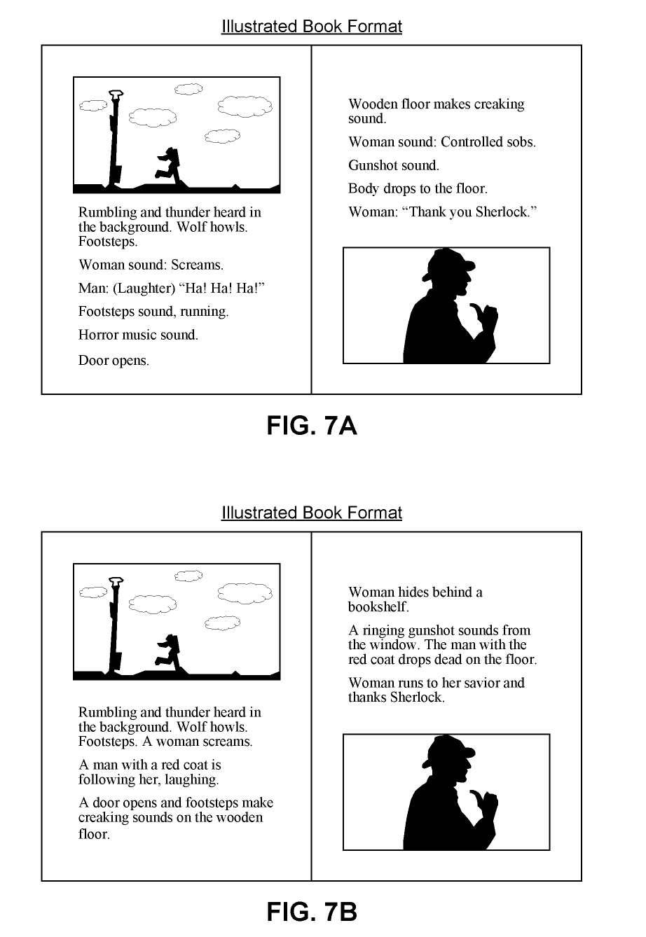

FIGS. 7A and 7B depict exemplary embodiments of an illustrated book format. An illustrated book format can be used when the input audio data is provided as a video. When the illustrated book format is selected, the audio transcription device 102 and/or transcription component 104 can extract audio data from the video as well as extracting video frames as images. The transcription component 104 can identify spoken words and/or other noises, and include transcriptions of identified words and descriptions of identified sounds in the transcript file 108, as described above for other presentation formats. The transcription component 104 can also add one or more images to each page in the transcript file 108, such that text based on audio identified from the video surrounds images from the video. The transcription component 104 can include images on a page that appear within the video at substantially the same point in time as audio used to generate the transcribed text on that page. By way of a non-limiting example, when transcribed text on a page is based on a 20 second sample of a video's audio, the transcription component 104 can include a video frame from that 20 second sample on the same page.

In some embodiments the transcribed text in an illustrated book format can follow a dialog or screenplay format in which identifiers for different speakers precede transcribed words and/or descriptions of identified non-vocal sounds are included, as described above. By way of a non-limiting example, FIG. 7A depicts an embodiment of an illustrated book format in which the text has been recognized from dialog and sound effects in the audio track of a movie, and frames of the movie have been inserted as images on the pages.

In other embodiments the transcribed text in an illustrated book format can follow the essay format without identifying the speaker. By way of a non-limiting example, FIG. 7B depicts an embodiment of an illustrated book format in which the text has been recognized from a single narrator who is describing what is occurring in a movie, while frames of the movie have been inserted as images on the pages.

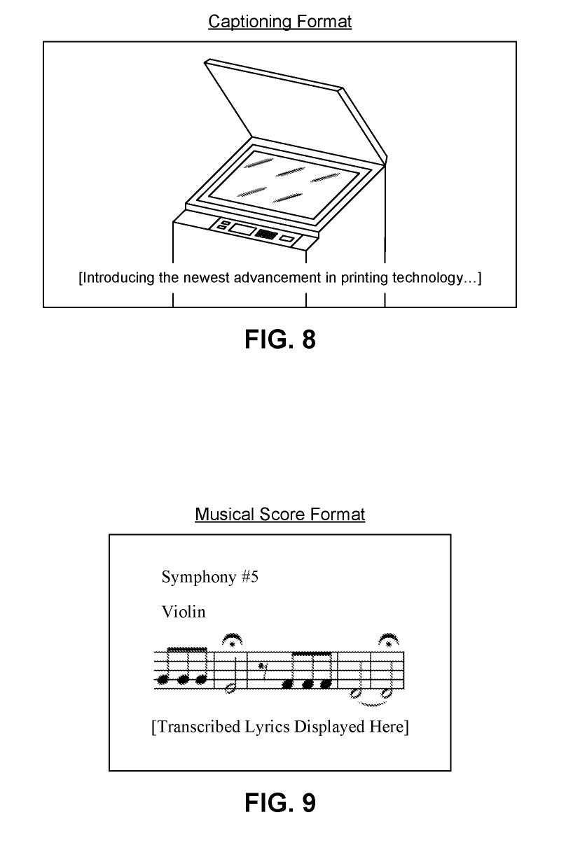

FIG. 8 depicts an exemplary embodiment of a captioning format. A captioning format can be used when the input audio data is a video. When the captioning format is selected, the audio transcription device 102 and/or transcription component 104 can extract audio data from the video and identify spoken words or sung lyrics. In some embodiments the transcription component can also attempt to identify other non-vocal data and find descriptions of those sounds using the sound database 106. In some embodiments the transcript file 108 generated by the transcription component 104 for the captioning format can be a copy of the original video that has the identified words and/or sound descriptions overlaid as fixed text over on the video, or that has that text embedded as closed captioning data that can be optionally displayed over the video. In alternate embodiment the transcript file 108 can be a closed captioning file that can be used along with the original video when users turn on a closed captioning feature.

In some embodiments the transcription component 104 can select the captioning format by default when the input audio data is identified by the transcription component 104 or via user input as a video. By way of a non-limiting example, a captioning format can be selected when the input audio data is any other type of video, such that the transcript file 108 can be used for subtitles when the video is played. By way of another non-limiting example, a captioning format can be selected when the input audio data is a music video, such that the transcription component 104 can identify the lyrics being sung over background music and generate captioning data that can be used for karaoke when the music video is played. In alternate embodiments still video frame images can be extracted from a music video and transcribed song lyrics can be displayed over or around the video frames in a static format for printing or display, similar to the illustrated book format described above.

FIG. 9 depicts an exemplary embodiment of a musical score format. A musical score format can be used when the input audio data is a recording of a song. The transcription component 104 can use musical instrument sounds 206 in the sound database 106 to identify which instrument is playing the song and identify individual notes and/or chords. The transcription component 104 can build sheet music on music staffs within a transcript file 108 using symbols associated with each identified note or chord. The symbols can be presented in the musical score format at a position that corresponds to a timestamp of the identified note or chord within the recording. The symbol used to represent a particular note can also be selected based on the length of time the transcription component 104 detected that note being played within the recording, such as a quarter note, half note, or whole note. When the instrument has been identified, in some embodiments the transcription component can use musical symbols specific to that instrument. In some embodiments, the names of notes or chords and/or solfège symbols can be added above or below musical symbols. When the input audio data includes sung or spoken lyrics in addition to musical sound produced by instruments and the transcription component 104 can transcribe the lyrics using vocal sounds 202, in some embodiments text corresponding to the transcribed lyrics can be inserted above or below musical symbols in the musical score format, as shown in FIG. 9.

As described above, the transcription component 104 can use information in the sound database 106 to generate a transcript file 108 based on audio recognized and identified within the input audio data. The transcription component 104 can use frequency analysis, pattern analysis, statistical analysis, machine learning, and/or artificial intelligence to compare audio segments from the input audio data against sound samples in the sound database 106 to find the best match. In some embodiments individual audio segments from the input audio data can be referred to as sound tokens 1100, as discussed further below. The transcription component 104 can use text mapped to an audio sample in the sound database 106 that best matches a sound token 1100 to transcribe that audio sample into text for the transcript file 108. In some embodiments the transcription component can be set to transcribe spoken words in the input audio data. In other embodiments the transcription component can be set to transcribe spoken words as well as other sounds, such as animal sounds, nature sounds, and other sound effects. In still other embodiments the transcription component can be set to transcribe spoken words and/or other sounds, as well as human singing and/or musical sounds produced by musical instruments.

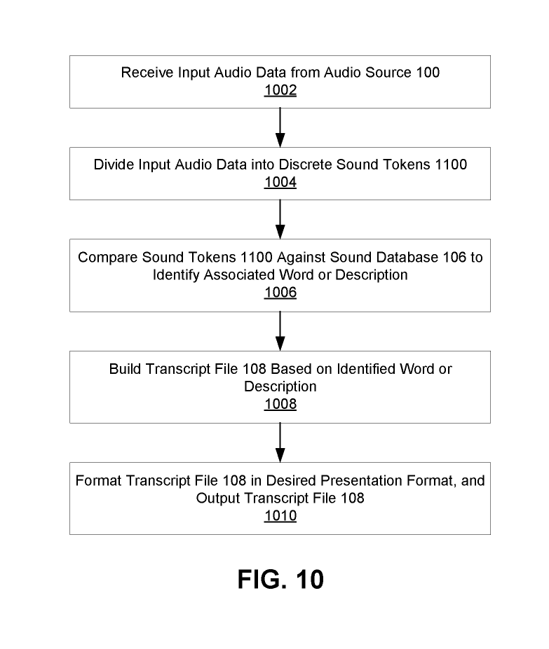

FIG. 10 depicts an exemplary embodiment of a process for generating a transcript file 108 with a transcription component 104.

At step 1002, an audio source 100 can provide input audio data to the audio transcription device 102. As described above the input audio data can be live or prerecorded sounds provided in audio or video data. If the input audio data is provided in an analog format, the audio transcription device 102 and/or transcription component 104 can convert the analog audio to digital audio using a device driver, software utility, or other processing component. Similarly, if the input audio data is provided as an un-encoded raw digital audio signal, the audio transcription device 102 and/or transcription component 104 can convert it into an encoded digital audio file. In some embodiments the transcription component 104 can use digital filtering, noise elimination, modulation, or other processing steps to clean the input audio data, such as eliminating static.

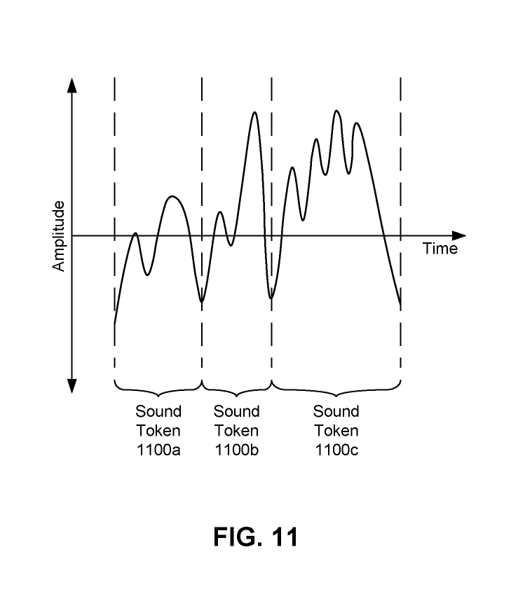

At step 1004, the transcription component 104 can divide the input audio data into discrete sound tokens 1100. As shown in FIG. 11, sound tokens 1100 can be segments of the input audio data that are identified by the transcription component 104 based on recorded sound waves in the input audio data. The transcription component 104 can perform a waveform analysis on sound waves in the input audio data to identify and extract sound tokens 1100 based on attributes of the sound waves, such as their amplitude or time between crests or troughs. For human speech, identified sound tokens 1100 can be partial words such as plosive consonants or phonemes, full words, or combinations of words. For other types of sounds, identified sound tokens 1100 can be partial sounds, full sounds bounded by periods of silence, or combinations of partial or full sounds.

In some embodiments the transcription component 104 can find local or global crests and troughs in a sound wave, and identify sound tokens 1100 as portions of the wave that are between identified crests or between identified troughs. As such, each sound token 1100 can have at least one wavelength.

By way of a first non-limiting example, FIG. 11 depicts a portion of a sound wave in which sound tokens 1100 have been identified between identified troughs at global minimums in the sound wave. As such, the sound tokens 1100 shown in FIG. 11 each have more than one wavelength that are each between global or local minimums in the sound wave. For example, the first sound token 1100a in FIG. 11 has two wavelengths, one wavelength between the first global minimum and a local minimum proximate to the center of the sound token 1100a, and another wavelength between the local minimum and the second global minimum.

By way of another non-limiting example, the transcription component 104 can identify sound tokens 1100 between each global or local trough or crest, such that each sound token 1100 has one wavelength. For example, the third sound token 1100c shown in FIG. 11 can instead be divided into four sound tokens 1100, one between each pair of troughs when both local and global minimums are considered.

In alternate embodiments the transcription component 104 can identify sound tokens 1100 in the input audio data by finding periods of sound bounded by periods of silence. The transcription component 104 can identify segments of the input audio data's sound wave with amplitudes that are likely to be silence or periods of low volume. The transcription component 104 can then identify sound tokens 1100 as segments of the sound wave that are between such periods of silence or low volume. By way of a non-limiting example, human speech typically has short periods of silence between spoken words. As such, sound tokens 1100 corresponding to individual spoken words can often be found by selecting sound data between identified periods of silence in a sound wave.

After sound tokens 1100 have been identified, the transcription component 104 can track timing attributes of the sound tokens 1100, such as how long they are and a timestamp of when they began within the input audio data. The transcription component 104 can also track other attributes of each sound token 1100, such as the number of wavelengths it contains, its minimum and/or maximum amplitude, information about its sequence of crests and troughs, or other information about the sound token's waveform.

In some embodiments the transcription component 104 can process each channel of multi-channel input audio data separately to identify sound tokens 1100 within each channel. By way of a non-limiting example, when the input audio data is a two-channel stereo or a 5.1 surround sound recording of dialog between two speakers that has been mixed such that one speaker's voice is primarily represented in one channel and the other speaker's voice is primarily represented in another channel, processing the sound channels separately can assist in identifying sound tokens 1100 associated with each distinct speaker.

At step 1006, the transcription component 104 can compare each identified sound token 1100 against audio data in the sound database 106 to find matching text or descriptions. The transcription component 104 can compare each sound token 1100 against prerecorded audio samples in the sound database 106 to find one that best matches the sound token 1100. In some embodiments the transcription component 104 can compare original sound tokens 1100 against audio samples. In other embodiments the transcription component 104 can transform original sound tokens 1100 to make them more similar to audio samples in the sound database 1100 prior to performing a comparison. By way of a non-limiting example the transcription component 104 can adjust the volume of a sound token 1100 by downscaling or upscaling the magnitude of its signal to more closely match the volume of known audio samples. By way of another non-limiting example the transcription component 104 can adjust the pitch of a sound token 1100 by shrinking or expanding the sound wave to more closely match the pitch of known audio samples.

In some embodiments the transcription component 104 can do a bitwise comparison between an original or transformed sound token 1100 and audio samples from the sound database 106 to find the closest matching audio sample. In other embodiments the transcription component 104 can compare an original or transformed sound token's waveform, or other attributes of the sound token 1100 such as its number of wavelengths, sequence of crests and troughs, pitch, frequency, or other attributes, against corresponding attributes of audio samples in the sound database 106 to find the closest match.

In some embodiments if the transcription component 104 does not find a sufficient match for a single sound token 1100, the transcription components 104 can compare combinations of two or more sound tokens 1100 against audio samples in the sound database 106.

As described above, the sound database 106 can comprise audio samples in a plurality of categories, including vocal sounds 202, animal sounds 204, musical instrument sounds 206, nature sounds 208, and/or sound effects 210. When the sound database 106 does contain audio samples from more than one category, the transcription component 104 can attempt to determine the category that is most likely to contain the closest match to an audio segment before performing further comparisons in the category.

In some embodiments the transcription component 104 can receive instructions from users that identify the most likely category. By way of a non-limiting example, a user who has listened to the input audio data can determine that it is primarily dialog between human speakers, and thus can instruct the transcription component 104 to prioritize comparisons between sound tokens 1100 and audio samples in the vocal sounds 202 portion of the sound database 106.

In other embodiments the transcription component 104 can use the file type of the input audio data to identify the most likely category. By way of a non-limiting example, input audio data provided as an MP3 can be likely to include musical sounds, and thus the transcription component 104 to prioritize comparisons between sound tokens 1100 and audio samples in the sung words 214 and/or musical instrument sounds 206 portions of the sound database 106. By way of a non-limiting example, input audio data provided as a video file can be likely to include dialog, music, and sound effects, and thus the transcription component 104 to prioritize comparisons between sound tokens 1100 and audio samples in the spoken words 212 musical instrument sounds 206, and/or sound effects 210 portions of the sound database 106.

In still other embodiments the transcription component 104 can use identify the most likely category based on representative samples in the sound database. In these embodiments one or more audio samples in each category can be designated as a representative sample for that category. The transcription component 104 can compare a sound token 1100 against a representative sample from a category to determine if a match for that sound token 1100 is likely to be found in that category. If the results of comparison between a sound token 1100 and a representative sample for a category is above a predefined threshold, the transcription component 104 can perform additional comparisons on other audio samples in that category. By way of a non-limiting example, the frequencies in a sound token 1100 of a human voice can be a closer match for a representative sample in the spoken words 212 category than one in the sound effects 210 category, and as such the transcription component 104 can prioritize further comparisons against other audio samples in the spoken words 212 category.

In some embodiments the transcription component 104 can group sound tokens 1100 based on common frequency ranges, common pitch ranges, or other factors that can identify sound data produced by the same source. As such, after a likely category of audio samples is determined for one sound token 1100 in a group, subsequent sound tokens 1100 in the group can be compared against audio samples in the same category.

At step 1008, the transcription component 104 can use mapping data between the closest-match audio samples and text descriptions of the audio samples to build the content of a transcript file 108. When an audio sample is determined to be a phoneme of human speech, the transcription component 104 can use surrounding phonemes in the input audio data to build words based on statistical measurements of the phonemes and/or other algorithms. As such, the transcription component 104 can add words or descriptions that match one or more sound tokens 1100 to the transcript file 108.

In some embodiments, when the transcription component 104 grouped sound tokens 1100 based on a common frequency range, pitch range, or other common attributes, the transcription component can add identifying text to the transcript file 108 for sound tokens 1100 in the group. By way of a non-limiting example, the transcription component 104 can use distinct frequency ranges and/or vocal patterns in sound tokens 1100 of human speech to identify sound tokens 1100 associated with different speakers within the input audio data, such that the transcript component 104 can add a label for each distinct speaker in the transcript file 108 in a dialog presentation format or other presentation format.

At step 1010, the transcription component 104 can format the transcript file 108 in a particular presentation format, and output the transcript file 108 for storage, printing, and/or display. In some embodiments, a user can input a command at the audio transcription device 102 to select a desired presentation format for the transcript file 108, either before the process begins or after words and sounds have been recognized. In other embodiments the transcription component 104 can attempt to identify an appropriate presentation format for the transcript file 108 based on one or more groups of recognized sound tokens 1100, as described below.

In some embodiments or situations the input audio data can already contain textual representations of its content when it is provided by an audio source 100. By way of non-limiting examples, the input audio data can be a video that contains closed captioning data and/or descriptive text that describes actions that are occurring during the video. In some embodiments, when the transcription component 104 receives input audio data that already contains textual representations of its content, it can move directly to step 1010 to format that textual representation in a selected presentation format. By way of a non-limiting example, the transcription component 104 can use pre-existing closed captioning data in a video as the text content of a transcript file 108 generated in an illustrated book format.

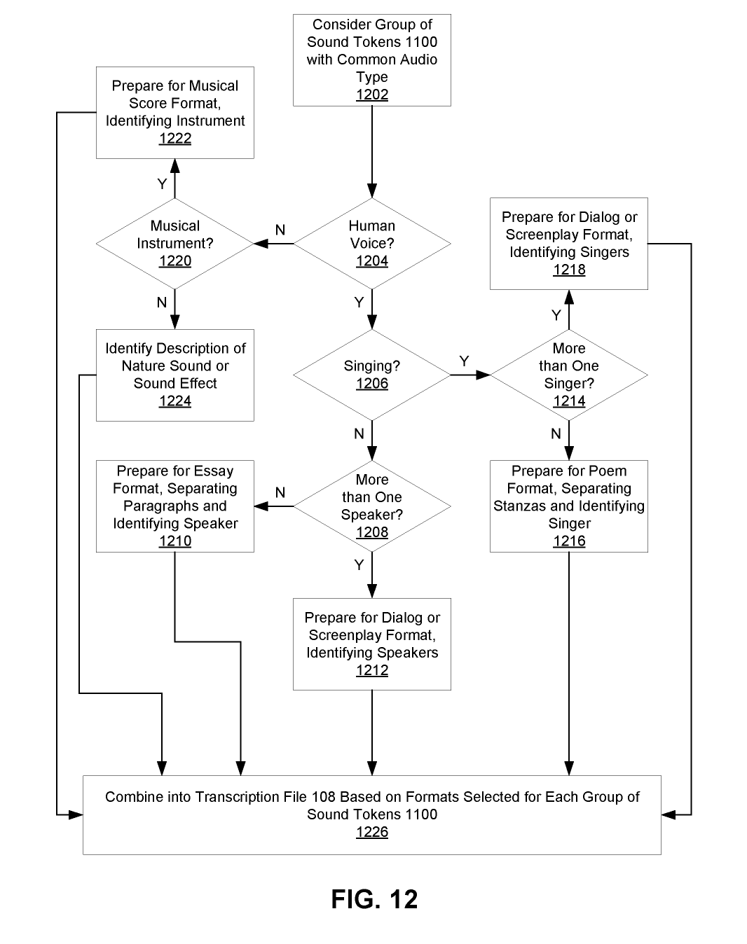

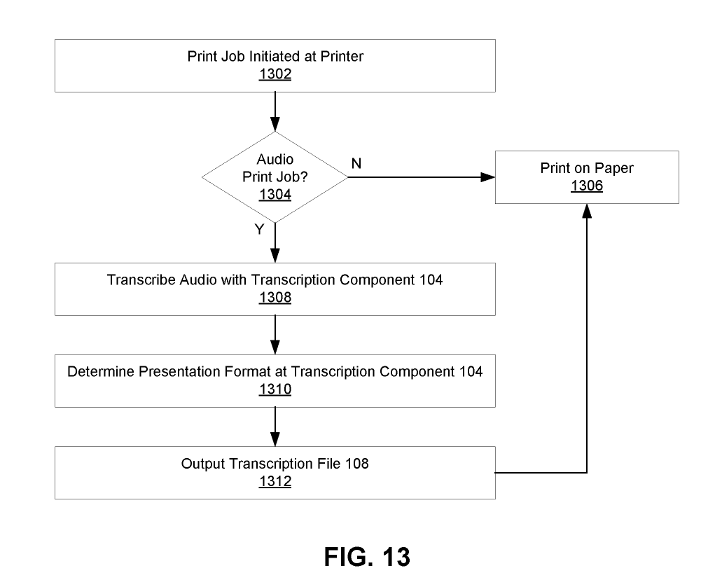

FIG. 12 depicts an exemplary process for selecting presentation formats for groups of sound tokens 1100 that can be combined into a final transcript file 108. As described above with respect to FIG. 10, the transcription component 104 can divide the input audio data into discrete sound tokens 1100 and find text associated with one or more segments based on the sound database 106. The transcription component 104 can consider groups of sound tokens 1100 that were determined through the process of FIG. 10 to share the same audio type, such as human speech, musical instrument sounds, or other sounds. The transcription component 104 can then find an appropriate presentation format for each group of sound tokens 1100, and then combine the presentation formats into a final transcript file 108.

At step 1202, the transcription component 104 can consider a group of sound tokens 1100 that were determined through the process of FIG. 10 to have the same audio type. By way of a non-limiting example, a group of sound tokens 1100 that were matched during the process FIG. 10 to audio samples in the vocal sounds 202 portion of the sound database 106 can be considered to have a human vocal sound audio type.

At step 1204, the transcription component 104 can determine if the shared audio type of the group of sound tokens 1100 was human vocal sounds. If the group's audio type was human vocals, at step 1206 the transcription component 104 can determine if the group's audio type was human speech or human singing.

If the transcription component 104 determines that the audio type of the group of sound tokens 1100 is human speech during step 1206, the transcription component 104 can determine at step 1208 whether the audio frequencies in the group indicate more than one speaker.

If at step 1208 the transcription component 104 identifies only one speaker in a group of sound tokens 1100 found to be human speech, at step 1210 it can prepare the text of the words mapped to the sound tokens 1100 during the process of FIG. 10 in a format suitable for use in the essay format. When the sound tokens 1100 were identified as silent pauses of more than a predetermined length, or the sound tokens 1100 were broken in the input audio data by periods of such silence, the transcription component 104 can insert paragraph breaks according to the essay format. In some embodiments the transcription component 104 can add an identifier of the speaker into the arranged text or in metadata, such that if sound tokens 1100 from a different speaker are found in other groups of sound tokens 1100, the speaker from the current group of sound tokens 1100 can be identified in the transcript file 108.

If at step 1208 the transcription component 104 identifies more than one speaker in a group of sound tokens 1100 found to be human speech, at step 1212 it can prepare the text of the words mapped to the sound tokens 1100 during the process of FIG. 10 in a format suitable for use in a dialog or screenplay format. The transcription component 104 can add an identifier of each speaker into the arranged text or in metadata, based on audio frequency analysis or other analyses that identifies different speakers within the group of sound tokens 1100.

Returning to step 1206, if the transcription component 104 determines that the audio type of the group of sound tokens 1100 is human singing, the transcription component 104 can determine at step 1214 whether the audio frequencies in the group indicate more than one singer.

If at step 1214 the transcription component 104 identifies only one singer in a group of sound tokens 1100 found to be human singing, at step 1216 it can prepare the text of the words mapped to the sound tokens 1100 during the process of FIG. 10 in a format suitable for use in the poem format. When the sound tokens 1100 were identified as silent pauses of more than a predetermined length, the transcription component 104 can insert stanza breaks according to the poem format. In some embodiments the transcription component 104 can add an identifier of the singer into the arranged text or in metadata, such that if sound tokens 1100 from a different singer are found in other groups of sound tokens 1100, the singer from the current group of sound tokens 1100 can be identified in the transcript file 108.

If at step 1214 the transcription component 104 identifies more than one singer in a group of sound tokens 1100 found to be human singing, at step 1218 it can prepare the text of the words mapped to the sound tokens 1100 during the process of FIG. 10 in a format suitable for use in a dialog or screenplay format. The transcription component 104 can add an identifier of each singer into the arranged text or in metadata, based on audio frequency analysis or other analyses that identifies different singers within the group of sound tokens 1100.

Returning to step 1204, if the transcription component 104 found that the group of sound tokens 1100 was not human speech or human singing, it can determine whether the group of sound tokens 1100 was sound produced by musical instruments.

If at step 1220 the group of sound tokens 1100 is found to be sound produced by musical instruments, at step 1220 the transcription component 104 can prepare the musical symbols mapped to the sound tokens 1100 during the process of FIG. 10 in a format suitable for use in a musical score format. The transcription component 104 can add an identifier of each musical instrument into the arranged musical symbols or in metadata.

If at step 1220 the group of sound tokens 1100 is not found to be sound produced by musical instruments, at step 1224 the transcription component 104 can prepare the text of a description of a nature sound or sound effect mapped to the sound tokens 1100 during the process of FIG. 10 in a format that can be used in a screenplay format or be inserted into any other format.

At step 1226 the transcription component 104 can select a final presentation format for the transcript file 108 based on the presentation formats selected during preceding for each group of sound tokens 1100 that share a common audio type. The transcript file 108 can use text formatted for different presentation formats in a single file, such as having some sections formatted in an essay format, some sections formatted in a dialog format, some sections formatted as a musical score, and some sections being descriptions of nature sounds or other sound effects inserted between other transcribed text. By way of a non-limiting example, if all of the sound tokens 1100 were human speech from the same speaker and the text was formatted for an essay format in step 1210, the transcription component 104 can generate the transcript file 108 in the essay format. However, if one group of sound tokens 1100 was human speech from one speaker, another group of sound tokens 1100 was human speech from two different speakers, and yet another group of sound tokens 1100 was sound effects, the transcription file 104 can generate the transcript file 108 in a screenplay format by inserting using the essay-formatted text from the single speaker and identifying it as being spoken by a narrator, inserting the dialog-formatted text from the two other speakers and identifying it as being spoken by individual characters, and inserting the text descriptions of other sound effects between the speech transcriptions.

If the audio input data was a video file, the transcription component can also at step 1226 use extracted frames and add them to the transcript file 108 along with text formatted in any other presentation format to create an illustrated book format. Similarly, the text formatted for any presentation format can be added to the video file as caption data for the captioning format.

FIG. 13 depicts an exemplary process for creating a transcript file 108 and printing it when the audio transcription device 102 is a printer and an audio input file is sent to the printer to begin a print job.

At step 1302, a print job can be initiated at the printer. In some embodiments the audio input file can be sent over a network connection to the printer to begin a print job, such as initiating a remote print job with the LPR (line printer remote) protocol or sending a file to the printer via an FTP (file transfer protocol) connection. In other embodiments a user can use a control panel or other user interface on the printer to select an audio input file from a local or networked data location to begin a print job.

At step 1304, the printer can determine whether the received print job is a regular print job or an audio print job. If the printer receives a file that has page content described by page description language (PDL) commands, the printer can determine that this is a regular print job. The printer can proceed at step 1306 to print the file by using a PDL raster image processor (RIP) to create raster representations of pages by interpret its PDL commands, and then printing the raster representations onto paper with the printer's print engine.

However, if at step 1302 the printer received an audio or video file to initiate the print job, it can determine that this is an audio print job and proceed to transcribing the audio at step 1308 and identifying a presentation format for the transcribed audio at step 1310.

At step 1308, the printer can run a transcription component 104 to find text associated with audio in the provided audio or video file for the transcript file 108, as described above with respect to FIG. 10. When the provided file is a video file, in some embodiments or situations the transcription component 104 can also extract video frames from the video.

At step 1310, the printer's transcription component 104 can determine a presentation format for the transcript file 108 based on the audio types for transcribed audio found during step 1308, as described above with respect to the process of FIG. 12. In alternate embodiments the presentation format can be selected by a user by inputting a command to the printer.

At step 1312, the transcription component 104 can output the transcript file 108 as a print job using PDL commands that describe the content of each page according to the selected presentation format. The printer can then proceed at step 1306 to print the file by using its PDL RIP to create raster representations of each page by interpreting the PDL commands, and then printing the raster representations onto paper with the printer's print engine.

In alternate embodiments, such as ones in which the printer is an MFP, the printer can be set to perform alternate operations based on a transcript file generated from an audio file or video file. By way of non-limiting examples, when an audio file is provided to an MFP to initiate a print job, the MFP can create a transcript file 108 based on the audio file as described in FIG. 13 and then prepare a PDF or image of pages in the selected presentation format that can be stored or transmitted to other devices. Similarly, when a transcript file 108 is generated by an MFP, the MFP can send an email to designated recipients indicating that the audio file has been processed for printing, the MFP can store the generated transcript file 108 in local storage or send it via FTP to another storage location, and/or the MFP can perform any other action upon transcribing the audio file and generating a transcript file 108.

As described above, a transcription component 104 can generate a transcript file 108 based on input audio data such that it can be printed and/or displayed in a presentation format. As such, audio from interviews, speeches, podcasts, audio blogs, movies, or any other source can be transcribed into text by a transcription component 104. The transcribed text can be printed, displayed on a screen, stored, transferred, searched, and/or be read or used for any desired purpose. By way of non-limiting examples, when audio from an interview with a historical figure is transcribed by the transcription component 104, the transcribed text can be stored in archives, presented or analyzed in news articles, or included in a textbook for students. By way of another non-limiting example, a transcript file 108 generated by a transcription component 104 from an audio source in one language can be provided to a translator to translate into another language.

Additionally, the formatting of a transcript file 108 into an appropriate presentation format can assist in allowing a reader to comprehend the content and/or context of the input audio data by how it is formatted. By way of a non-limiting example, generating a transcript file 108 in a dialog format from a recording of a conversation between two people can help a reader understand which person spoke which word in the original audio.

In some embodiments a transcription component 104 can be activated on demand upon the occurrence of a particular event. By way of non-limiting examples, a printer can activate a transcription component 104 when a print job is initiated at a printer based on an input audio file. Similarly, a transcription component 104 at a standalone audio transcription component 102 can be activated when a user inputs a command to transcribe a particular piece of input audio data.

In other embodiments a transcription component 104 can be activated automatically as part of a service. By way of a first non-limiting example, a transcription component 104 can be integrated into a teleconference service. In this example the audio source 100 or the audio transcription device 102 can be a teleconferencing server through which remote business partners or team members can connect to over the internet or via phone to conduct a meeting. The teleconferencing server can record audio of the meeting, and provide the audio to a transcription component 104. The transcription component 104 can generate a transcript file 108 in a particular presentation format, such as a dialog format. The teleconferencing service can then email the transcript file 108 to the meeting attendees and/or others who were not in attendance, such that they can have a copy of transcribed text from the meeting for their records. Similarly, the teleconferencing service can archive a copy of the transcribed text or make it available to users on a web site.

By way of a second non-limiting example, a transcription component 104 can be integrated into a security service. In this example the audio source 100 can be one or more microphones set up around an environment that is being monitored by the security service. The microphones can be set up to record ambient audio on a permanent basis or during selected time periods. In some embodiments the microphones can record audio when they detects noise at higher than a designated volume threshold, while in other embodiments they can record audio indefinitely. The microphones can pass recorded audio to an audio transcription device 102 running a transcription component 104, such that it can generate a transcript file 108 from the recorded audio. In some embodiments the audio transcription device 102 can enter a power-saving mode when not transcribing recorded audio, but wake up when audio is received from the microphones. When transcript file 108 contains a transcription of recorded noise, the security system can notify a user, email the transcript file 108 to a user, and/or archive the transcript file 108 for later review. In some embodiments, if the security system comprises one or more cameras, images from the cameras can be included in a transcript file 108 along with transcribed text.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A method of generating a transcript file, comprising:
receiving input audio data at an audio transcription device running a transcription component;
dividing the input audio data into a plurality of sound tokens at the transcription component;
identifying transcription text for each subset of the plurality of sound tokens by finding a best match for the subset in sound samples in a sound database; and
creating a transcript file and formatting the transcription text in the transcript file according to a presentation format that corresponds to a sound type of the transcription text.

2. The method of claim 1, wherein transcription text is identified for a sound token by comparing the sound token against representative sound samples in a plurality of audio categories, identifying a best-match audio category that has a representative sound sample that is the closest match to the sound token, and performing additional comparisons against other sound samples in that best-match audio category to find the best match sound sample.

3. The method of claim 1, wherein sound tokens are divided by analyzing the waveform of the input audio data and identifying segments between crests or troughs in the waveform.

4. The method of claim 1, wherein sound tokens are divided by analyzing the input audio data and identifying segments between periods of silence.

5. The method of claim 1, wherein the presentation format for a subset of the plurality of sound tokens is selected as an essay format when the subset is determined to be human speech by a single speaker, and wherein transcribed text in the essay format is separated by paragraph breaks when periods of silence longer than a predetermined time period are detected in the subset of the plurality of sound tokens.

6. The method of claim 1, wherein the presentation format for a subset of the plurality of sound tokens is selected as a poem format when the subset is determined to be human singing, and wherein transcribed text in the poem format is separated by stanza breaks when periods of silence longer than a predetermined time period are detected in the subset of the plurality of sound tokens.

7. The method of claim 1, wherein the presentation format for a subset of the plurality of sound tokens is selected as a dialog format when the subset is determined to be human speech by two or more distinct speakers based on a frequency analysis that identifies two or more distinct frequency ranges in the sound tokens, and wherein the transcription component inserts an identifier for each distinct speaker into the dialog format before transcribed text associated with that distinct speaker.

8. The method of claim 1, wherein the presentation format for a subset of the plurality of sound tokens is selected as a screenplay format when some portions of the subset are determined to be human speech and other portions are determined to be sound effects.

9. The method of claim 1, wherein the input audio data is a video and wherein the presentation format is an illustrated book format that inserts one or more images extracted by the transcription component from the video's visual components among text transcribed by the transcription component from the video's audio component.

10. The method of claim 1, wherein the presentation format for the plurality of sound tokens is selected as a captioning format when the input audio data is a video, and wherein the transcription component overlays the video with text transcribed by the transcription component from the video's audio component.

11. The method of claim 1, wherein the presentation format for a subset of the plurality of sound tokens is a musical score format when the subset is determined to be sounds produced by musical instruments, and wherein the transcription component inserts musical symbols corresponding to notes and/or chords identified by the transcription component.

12. The method of claim 1, wherein the sound database comprises prerecorded samples of phonemes of human speech and rules for assembling one or more phonemes into words to generate transcribed text.

13. The method of claim 1, further comprising outputting the transcript file to a print engine to be printed on paper according to the presentation format.

14. The method of claim 1, further comprising outputting the transcript file for display on a screen according to the presentation format.

15. A printer, comprising:
a transcription component that follows a set of instructions to:
receive input audio data when a print job is initiated at the printer;
divide the input audio data into a plurality of sound tokens;
identify transcription text for each subset of the plurality of sound tokens by finding a best match for the subset in sound samples in a sound database;
create a transcript file and format the transcription text in the transcript file according to a presentation format that corresponds to a sound type of the transcription text; and
a print engine configured to print images on paper based on the transcript file according to the presentation format.

16. The printer of claim 15, wherein the printer activates the transcription component when a print job is initiated to print an audio file.

17. The printer of claim 15, wherein the printer generates the transcript file using page description language commands that indicate to the print engine how to print transcribed text in the presentation format.

18. An audio transcription device, comprising:
a processor;
digital memory;
a microphone configured to record input audio data and store said input audio data as a digital file in the digital memory; and
a non-transitory machine-readable medium having instructions recorded thereon for causing the processor to perform the steps of:
dividing the input audio data into a plurality of sound tokens;
identifying transcription text for each subset of the plurality of sound tokens by finding a best match for the subset in sound samples in a sound database;
creating a transcript file and formatting the transcription text in the transcript file according to a presentation format that corresponds to a sound type of the transcription text; and
storing the transcript file in the digital memory; and
a data interface configured to transfer the transcript file from the digital memory to a separate device.

19. The audio transcription device of claim 18, wherein the processor generates the transcript file in a file format that can be natively displayed in the presentation format on a screen with the separate device.

20. The audio transcription device of claim 18, wherein the processor generates the transcript file using page description language commands that indicate to a printer how to print transcribed text in the presentation format.
